(19) United States
(12) Patent Application Publication
(10) Pub. No.: US 2002/0041410 A1
(43) Pub. Date: Apr. 11, 2002

(54) Bi-directional wavelength switched ring optical protection switching wavelength assignment algorithm

(75) Inventors: Naimish Patel, North Andover, MA (US); Murat Azizoglu, North Billerica, MA (US); Edmond Lee, Cambridge, MA (US)

Correspondence Address: WEINGARTEN, SCHURGIN, GAGNEBIN & HAYES LLP, Ten Post Office Square, Boston, MA, 02109, US

(73) Assignee: SYCAMORE NETWORKS, INC.

(21) Appl. No.: 09/899,358

(22) Filed: Jul. 5, 2001

Related U.S. Application Data
(60) Provisional application No. 60/216,892, filed on Jul. 7, 2000.

(51) Int. Cl. H04B 10/08; H04J 14/02

(52) U.S. Cl. 359/124; 359/110

(57) ABSTRACT

Methods for allocating connections between nodes in an optical ring communications network are provided. In these methods, working path connections are assigned so that the combination of required wavelengths and wavelength interface cards (WICs) in the network is minimized. In one such method, the wavelengths for the working path connections are assigned so that lightpaths are connected around the ring to complete a circle. In another method, components of lightpaths are connected so that a linked component group of lightpaths is formed around the ring until no more connectable lightpath connections are available or until a complete circle is formed around the ring.

### CROSS REFERENCE TO RELATED APPLICATIONS

This application claims priority under 35 U.S.C. §119(e) to provisional patent application Ser. No. 60/216,892 filed Jul. 7, 2000, the disclosure of which is hereby incorporated by reference.

### STATEMENT REGARDING FEDERALLY SPONSORED RESEARCH OR DEVELOPMENT

N/A

### BACKGROUND OF THE INVENTION

Wavelength Division Multiplexing (WDM) ring networks are commonly known for use in commercial products and are being widely used by telecommunication carriers. In specific applications, WDM networks are used in the form of rings and higher level networks are used in the form of SONET/SDH self-healing rings. For these networks to operate, it is necessary to provide switching equipment in the nodes for terminating, originating and regenerating the traffic in the lightpaths. This switching equipment contributes significantly to the overall cost of the network.

One aspect of WDM ring networks is the assignment of wavelengths to carry the traffic over the lightpaths. The problem of wavelength assignment for the lightpaths has been previously addressed by minimizing the number of wavelengths required for the given lightpath connections. However, by restricting the design analysis to minimizing the number of required wavelengths, the overall cost of the entire network may be neglected. A given wavelength assignment may require more switching equipment than alternative assignments using more wavelengths. Therefore, a method is desired for assigning wavelengths for a set of lightpath connections in which the overall cost of the system based on the number of assigned wavelengths and the switching equipment is considered.

### BRIEF SUMMARY OF THE INVENTION

The present invention is directed to assigning the working path connections in a WDM ring network that minimizes the combined needs for wavelengths and Wavelength Interface Cards (WICs). The methods for assigning wavelengths to the working path connections according to the embodiments of the present invention reduces the number of required wavelengths to a value close to the optimal solution for solving the wavelength assignment problem alone and the number of required WICs to a value close to the optimal solution for solving the switching equipment problem alone. By solving these problems in combination, the combined needs of wavelengths and WICs are minimized.

In one disclosed method, the wavelengths for the working path connections are assigned so that lightpaths are connected to form complete circles around the ring where possible. In another method, components of lightpaths are connected so that a linked component group is formed around the ring until no more connectable lightpath connections are available or until a complete circle is formed around the ring.

Other aspects, features and advantages of the present invention are disclosed in the detailed description that follows.

### BRIEF DESCRIPTION OF THE SEVERAL VIEWS OF THE DRAWING

The invention will be more fully understood by reference to the following detailed description of the invention in conjunction with the drawings, of which:

FIGS. 1(a), 1(b), and 1(c) illustrate span switching, link switching, and path switching protection mechanisms, respectively, as known in the art;

FIGS. 2(a), 2(b), and 2(c) illustrate bandwidth allocation utilizing path switching in a BWSR;

FIGS. 3(a) and 3(b) illustrate the efficiency of wavelength usage in paired protection schemes for BWSRs;

FIGS. 4(a) and 4(b) illustrate the efficiency of switching equipment usage in paired protection schemes for BWSRs;

FIG. 5 illustrates a BWSR utilizing a paired protection scheme;

FIGS. 6(a) and 6(b) are flow charts illustrating light path grouping schemes; and

FIGS. 7(a), 7(b), 7(c), and 7(d) illustrate working path assignments in paired protection schemes.

### DETAILED DESCRIPTION OF THE INVENTION

Various protection architectures are known for Wavelength Division Multiplexing (WDM) in optical fiber ring networks. One such protection architecture is a Bidirectional Wavelength Switched Ring (BWSR) architecture that supports duplex traffic where working paths and protection paths are allocated for each lightpath connection in the BWSR. Connections are typically established over the working path. However, when a network failure occurs in which the working path for a connection is no longer available, the connection is quickly switched to its protection path to restore communication.

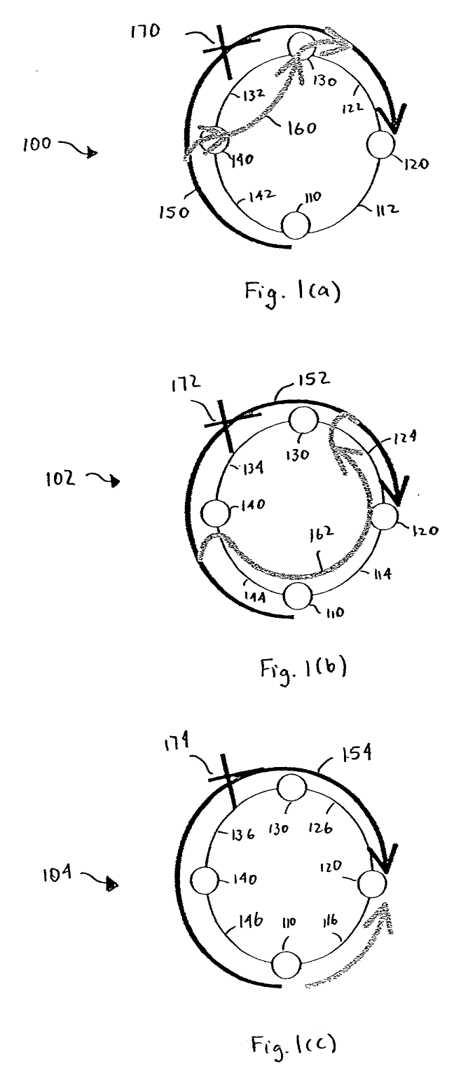

Examples of protection mechanisms that may be implemented on a BWSR include span switching 100, link switching 102, and path switching 104 as illustrated in FIGS. 1(a), (b), and (c) for nodes 110, 120, 130, and 140. In each of FIGS. 1(a), (b), and (c), communication is desired between nodes 110 and 120. In span switching 100, spare channels (such as wavelength or fiber, for example) are provisioned for every span 112, 122, 132, and 142 between the nodes. If a failure 170 occurs between nodes 130 and 140, communication for a lightpath 150 in a clockwise direction between nodes 110 and 120 cannot be completed. In this case, span switching switches to a spare channel 160 for the span 132 which bypasses the failure 170 and provides communication between nodes 110 and 120. In link switching 102 as illustrated in FIG. 1(b), a lightpath protects each of the links 114, 124, 134, and 144 between the nodes. In this example a failure 172 occurs between nodes 130 and 140, and communication will be switched to lightpath 162.

Path switching 104 includes working paths and protection paths wherein a protection path is provided for every working path such that the protection path is edge-disjointed with the corresponding working path. For example, FIG. 1(c) illustrates a working path 154 and its respective protection path 164. When a failure 174 occurs in the working path 154 between the nodes 130 and 140 as shown in this example, the traffic is switched to the protection path 164 in a route completely different from the working path 154 such that the working path 154 is not traversed. In contrast with other switching techniques where switching equipment is required at every node that a connection traverses, the amount of necessary switching equipment is reduced in path switching because switching equipment is only required at the end nodes.

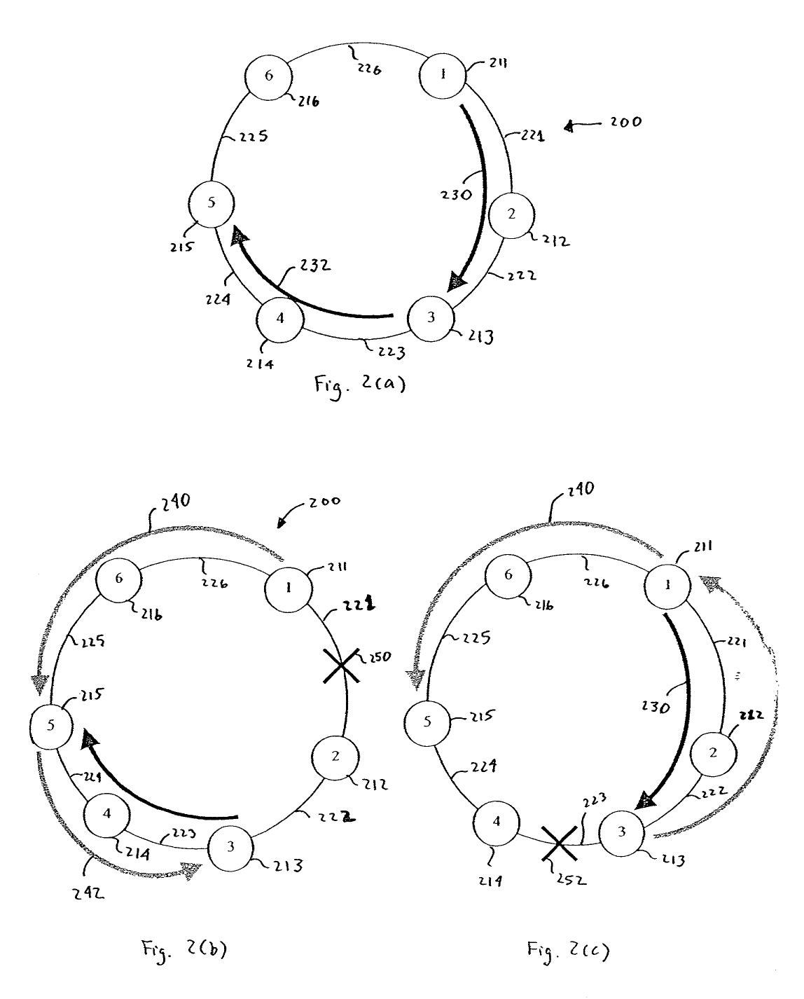

FIGS. 2(a), (b), and (c) depict a BWSR 200 utilizing path switching and the bandwidth allocation for exemplary connections. The BWSR 200 includes a plurality of nodes 211, 212, 213, 214, 215, and 216 connected by optical fiber links 221, 222, 223, 224, 225, and 226. Two wavelengths, λ₁ and λ₁′, are used for the working path and protection path connections, respectively. The working path connections are used for communication under normal conditions, and the protection path connections are used for communication when failures occur on the working paths. In FIG. 2(a), a first lightpath connection 230 originates at node 211 and terminates at node 213, and a second lightpath connection 232 originates at node 213 and terminates at node 215.

If a link fails anywhere within a working path connection, the connection is switched to the corresponding protection path. For instance, FIG. 2(b) illustrates the failure of the link 221 such that normal communication is broken over the wavelength λ₁ for the working path 230. As a result, switching mechanisms (not shown) at nodes 211 and 213 switch the connection to protection path connections 240 and 242 on wavelength λ₁′ so that the connection still originates at node 211 and terminates at node 213. However, this protection path connection is in a different direction and on a different wavelength than the original connection. Similarly, if link 223 fails for the working path 232 as illustrated in FIG. 2(c), the switching mechanisms (not shown) at nodes 213 and 215 switch the connection to protection path connections 244 and 240 on wavelength λ₁′. Thereby, the protection path connection still originates at node 213 and terminates at node 215.

It is realized that the bandwidth in wavelength λ₁′ may potentially be used by one of two different protection path connections (in FIG. 2(b), 240-242 and in FIG. 2(c), 244-240). In the case of a link failure, only one of the connections will use wavelength λ₁′. As long as only one link fails at a time, traffic from multiple working connections will never have to use the same protection channel. Therefore, more than one protection path may be assigned to the same wavelength λ₁′ even while sharing some common links. Because of protection path bandwidth sharing, a protection path connection may undergo regenerations along the path that increases the amount of necessary network equipment. Specifically, as illustrated in FIGS. 2(b) and 2(c), the protection path connection 240 is a segment that is shared in the protection paths for both working path connections 230 and 232. As a result, network equipment must regenerate the connection for these protection paths at node 215. Examples of the network equipment include Optical Filtering Cards (OFCs), and Wavelength Interface Cards (WICs) for performing add/drop, termination, regeneration, and optical pass-through for different wavelength channels at the nodes.

The network design problem for BWSR involves routing, grooming, wavelength assignment and network configuration. More particularly, given a set of traffic demands and network architecture, the equipment that should be installed at each node in the network and the network resources that should be allocated are determined. The traffic demand includes a set of connections where each connection is defined by its source node, destination node, and requested bandwidth. The network architecture includes the number of nodes and the set of wavelengths supported by the network, the bandwidth capacity (in terms of OC-48 units, for example) for each wavelength, and the set of available OFCs.

A solution for the BWSR network design problem should consist of routing, wavelength, and timeslot assignment for each connection, and the configuration for each node. Specifically, the route (clockwise or counter-clockwise), the working and protection wavelengths assigned, and the timeslot(s) assigned (as a result of grooming) for each connection should be specified. Also, the set of OFCs to be installed at each node, and the WICs to be installed for each interface should be specified such that the routing and wavelength assignments for the connections are supported. For instance, the source and destination nodes should be equipped with an OFC that drops the wavelength and WICs terminating the wavelength should be installed at the appropriate node interfaces.

Paired protection is a protection wavelength assignment scheme having advantageous features for solving network design problems. In general, half of the designated wavelengths are dedicated for the working path connections and the other half are dedicated for the protection path connections. Furthermore, all of the working path connections that use a wavelength (λ, for example) must use a complementary wavelength (λ′, in this example) for their protection path connections. One of the advantageous features of the paired protection scheme is that the network design problem is essentially reduced to wavelength assignment for the working path connections. Once the working path connections are assigned to a wavelength, the wavelength assignment for the protection path connections is automatically determined. Also, a working path wavelength is always protected by the same protection path wavelength so that paired protection is simple in terms of signaling and configuring. Furthermore, the structured relationship between the working and protection wavelengths simplifies the OFC architecture design because the OFC drops pairs of wavelengths.

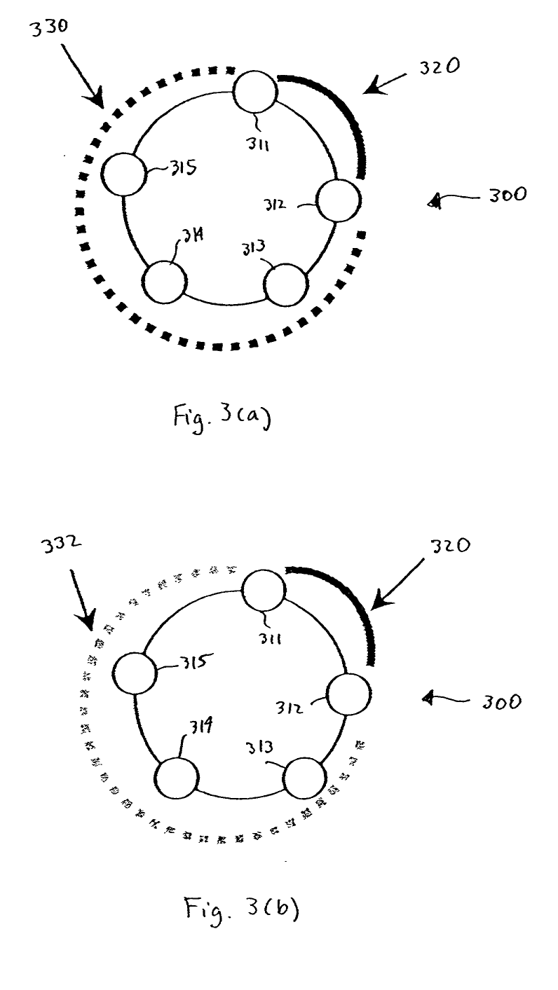

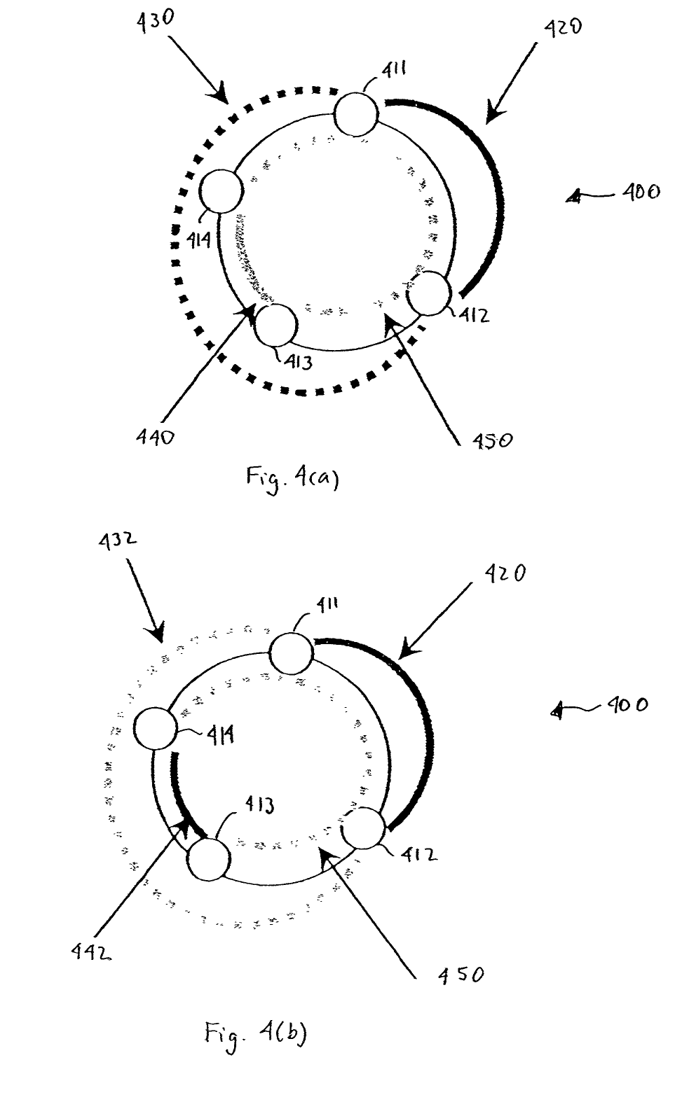

However, the constraints associated with the structured relationship of the paired protection scheme may cause a sub-optimal wavelength assignment in terms of both the number of wavelengths and the number of WICs required in the network design. FIGS. 3(a) and 3(b) illustrate an example where the paired protection scheme causes a sub-optimal usage of wavelengths. For the network 300 in FIG. 3(a), the connections between nodes 311 and 312 for a working path 320 and its protection path 330 are assigned to one wavelength, λ₁. However, when the paired protection scheme is used for the same connections, one wavelength, λ₁, is used for the working path connection and another wavelength, λ₂, is used for the protection path connection as illustrated in FIG. 3(b). As a result, the connection for a protection path 332 is assigned to wavelength λ₂ while the working path 320 remains assigned to wavelength λ₁ and two wavelengths are sub-optimally used.

FIGS. 4(a) and 4(b) illustrate an example where the paired protection scheme causes a sub-optimal usage of WICs. For the network 400 in FIG. 4(a), the connections between nodes 411 and 412 for a working path 420 and its protection path 430 are assigned to wavelength, λ₁, and the connections between nodes 413 and 414 for a working path 440 and its protection path 450 are assigned to wavelength, λ₂. This results in the need of 8 WICS, 4 WICs for the working path connections (one WIC at each of the respective originating and terminating nodes 411, 412, 413, and 414) and 4 WICs for the protection path connections (another WIC at each of the respective originating and terminating nodes 411, 412, 413, and 414).

However, when the paired protection scheme is used for connections between the same nodes, one wavelength, λ₁, is used for only the working path connections and the other wavelength, λ₂, is used for only the protection path connections. As illustrated in FIG. 4(b), the working path connection 420 remains assigned to wavelength λ₁ but a working path connection 442 between nodes 413 and 414 is now assigned to wavelength λ₂. A protection path 432 for the working path 420 is then assigned to wavelength λ₂ while the protection path 450 remains assigned to wavelength λ₂. In this case, a need for 12 WICS results, 4 WICs for the working path connections (one WIC at each of the respective originating and terminating nodes 411, 412, 413, and 414) and 8 WICs for the protection path connections (another WIC at each of the respective originating and terminating nodes 411, 412, 413, and 414 and an additional regeneration WIC at each of the nodes 411, 412, 413, and 414). Accordingly, the paired protection scheme sub-optimally uses 4 additional WICS.

In general, assuming that the wavelengths are assigned to connections, and k designates the number of connections assigned to each working wavelength, 4k WICs is the lower bound for the combined working and protection lightpaths for these k connections. For instance, when k=1, 4 WICs are needed for the connection and this is also the optimal configuration. When k>1, the connections need 2k WICs for the working path connections. With P representing the set of end nodes for the k connections, for each of the nodes in P, 2 WICs (1 WIC for the east connection and 1 WIC for the west connection) are needed for the protection path connections. Therefore, the number of WICs needed for the protection paths is 2P. If P=k (the connections cover a full circle), then the total number of WICs required is the optimal value of 4k. The paired protection scheme may be more readily used if the combination of these optimal values for the needed WICs and wavelengths is minimized.

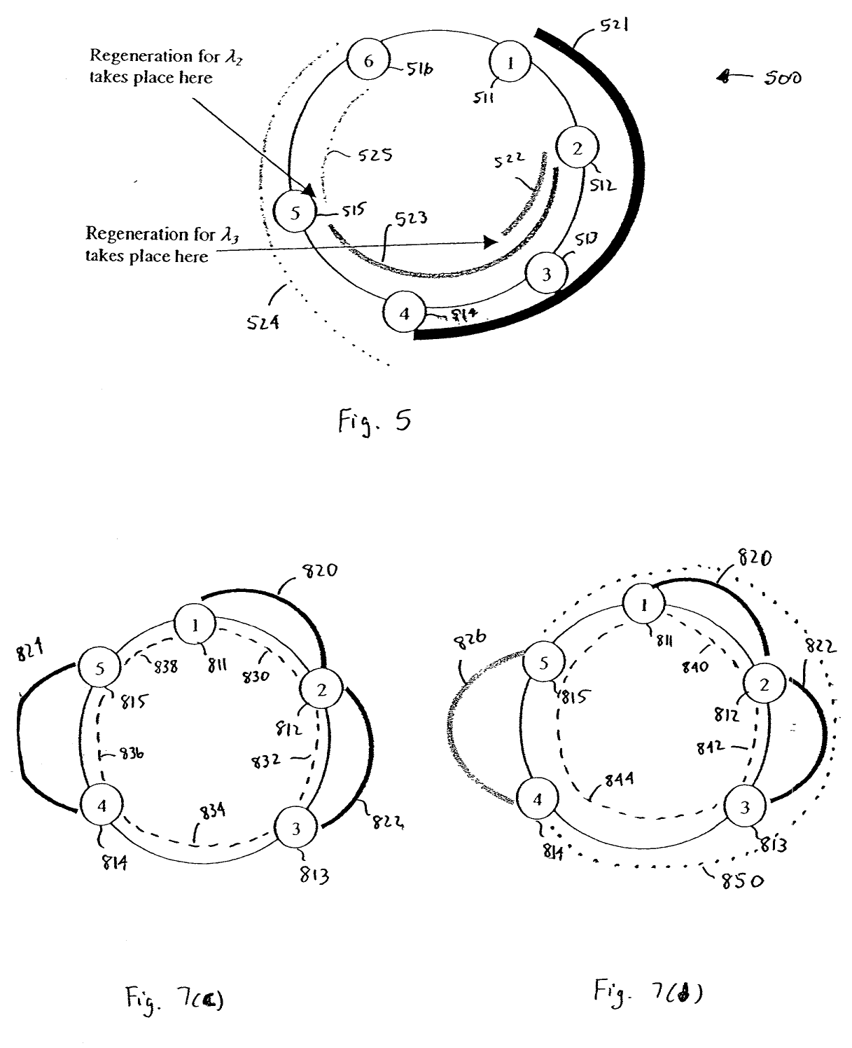

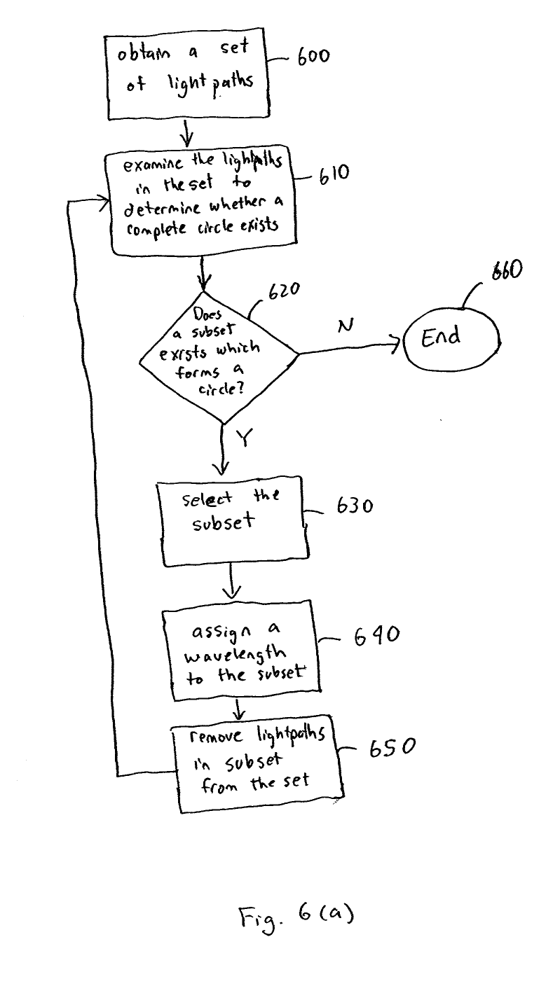

FIG. 5 illustrates an example of a solution to a network design problem for a BWSR 500 utilizing a paired protection scheme. In this paired protection scheme, all connections on working paths having a wavelength λ₁ are protected by connections on protection paths having a wavelength λ₄ (the protection path connections are omitted for simplicity of the figure). Similarly, connections on working paths having wavelengths λ₂ and λ₃ are protected by connections on protection paths having wavelengths λ₅ and λ₆, respectively. The BWSR includes nodes 511, 512, 513, 514, 515, and 516 supported by the wavelengths λ₁, λ₂, ₃, λ₄, λ₅, and λ₆. The traffic demand is shown in Table 1 below:

TABLE 1

| | | Bandwidth |
|---|---|---|
| | | Requests |
| Connection | End Nodes | (OC-48 units) |
| 521 | (1, 4) | 4 |
| 522 | (2, 3) | 2 |
| 523 | (2, 5) | 2 |
| 524 | (4, 6) | 1 |
| 525 | (5, 6) | 1 |

Using shortest-path routing, the working wavelength assignment is shown in Table 2 below:

TABLE 2

| Wavelength | Timeslot | Connection |
|---|---|---|
| λ₁ | 1 | 521 |
| λ₁ | 2 | 521 |
| λ₁ | 3 | 521 |
| λ₁ | 4 | 521 |
| Λ₂ | 1 | 524 |
| Λ₂ | 2 | 525 |
| Λ₂ | 3 | Idle |
| Λ₂ | 4 | Idle |
| Λ₃ | 1 | 522 |
| Λ₃ | 2 | 522 |
| Λ₃ | 3 | 523 |
| Λ₃ | 4 | 523 |

Two types of optical filter cards (OFCs) are used in this example. A first OFC F₁ drops (λ₁, λ₂, λ₄, and λ₅), and a second OFC F₂ (λ₂, λ₃, λ₅, and λ₆). Thereby, the node configuration is shown in Table 3 below:

TABLE 3

| Node | OFC |
|---|---|
| 511 | F₁ |
| 512 | F₂ |
| 513 | F₂ |
| 514 | F₁ |
| 515 | F₂ |
| 516 | F₁ |

The primary objective in obtaining a solution is to find one routing, wavelength assignment and configuration that supports the traffic demand. A secondary objective is to minimize the cost of the network that is generally a function of the amount of required network equipment for the configuration. In the solution of FIG. 5, 20 WICs and 6 OFCs are required. It is generally desirable to find a solution for traffic demand that minimizes the amount of WICs and OFCs needed and reduces the cost of the network.

The methods for assigning wavelengths according to the embodiments of the present invention generally include grouping lightpaths and assigning wavelengths. In lightpath grouping, non-overlapping lightpaths are grouped so that each group of lightpaths is assigned to the same wavelength and the total number of required WICs is minimized.

In one embodiment of the present invention, a method of assigning the lightpath connections to complete a circle in paired protection schemes for network configurations is provided so that the required number wavelengths and WICs is minimized. If a set of connections exactly covers the BWSR, then the set of all of the end points are shared. By assigning the same wavelength to this set of connections, only 4k WICs are needed for the connections, which is the lower bound and optimal number of connections. The method according to the present embodiment examines a set of lightpaths and finds a subset of the lightpaths that exactly covers the ring so that the usage of WICs is optimized.

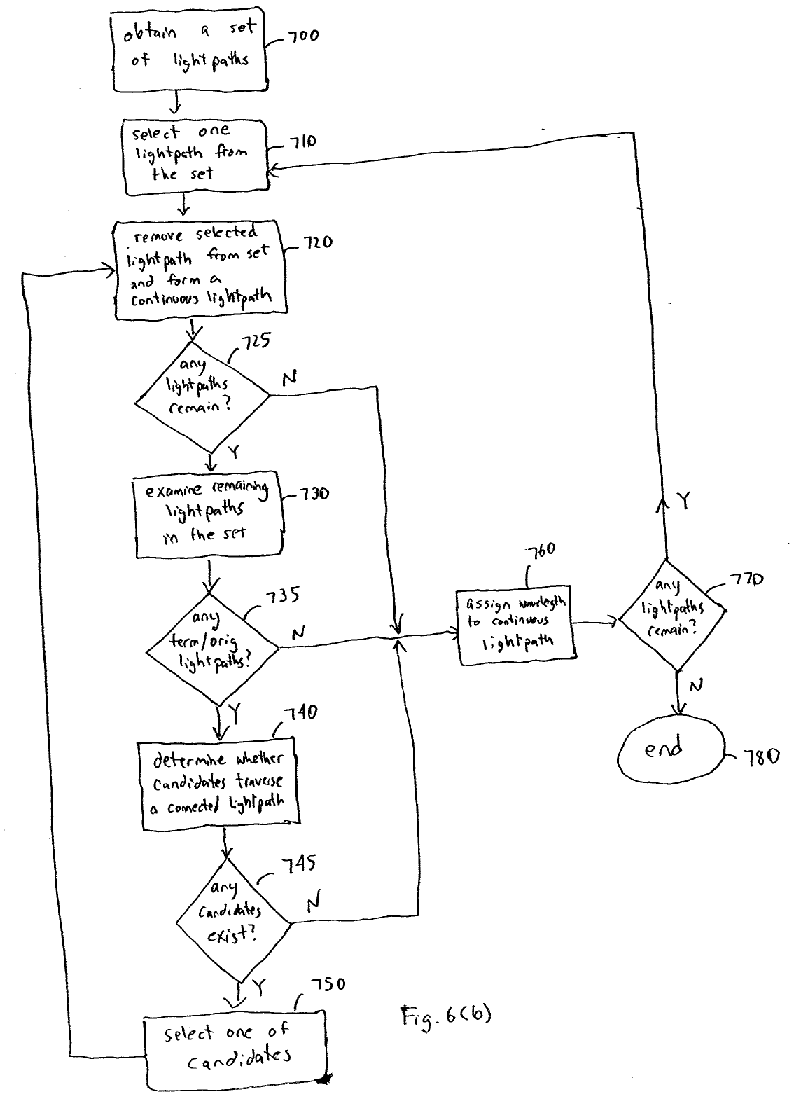

FIG. 6(a) is a flow chart illustrating an embodiment of this method. At step 600, a set of lightpath connections for the nodes in a ring is obtained. These connections represent the traffic demand. Next, the set of lightpath connections is examined at step 610 to determine whether a subset of lightpath connections exist which forms a circle. The subset of lightpath connections will be determined to form a circle if at each node there is either one origination or termination of a lightpath connection or a single traversal of the node by a lightpath connection. If a determination is made at step 620 that a subset exists which forms a circle, the subset is selected at step 630. Then, a unique wavelength is assigned to the subset at step 640. The selected subset is removed from the set at step 650 and the new set of lightpaths having the subset removed is examined again at step 610. Steps 610-650 are repeated until no more subsets are determined to exist at step 620 and the method is completed at step 660.

In determining whether a subset of lightpath connections exists which form a circle at step 610, various algorithms may be used. In general, an algorithm takes in a set of arcs and tries to divide the arcs into groups which forms a complete circle. An arc A is defined as a segment on a ring, which corresponds to a lightpath connection. A complete circle C is a set of arcs, which can be joined together to form a complete circle. A partial circle Y is a set of arcs, which can be joined together to form a continuous part of a circle but not a complete circle. An arc x extends a partial circle Y if Y∪{x} is a partial circle or a complete circle.

In one embodiment of a find-circle algorithm, a RETRIEVE_CIRCLE module takes in a partial circle Y and a set of arcs A and recursively finds some arcs in A that completes the partial circle Y. In finding arcs in A to complete the partial circle Y, more than one arc may be returned as a potential candidate to extend the partial circle. Various criteria may be used for selecting from the arcs that extend the partial circle without forming the complete circle. For example, selecting the longest arc is one such selection criteria that may be used. Once a complete circle C is found, the set of arcs in the circle is returned. If no such set of arcs can be found, an empty set φ is returned.

In the main procedure of this algorithm, FIND_CIRCLES, a set of arcs A is input and the RETRIEVE_CIRCLE module is repeatedly called. Each time that the RETRIEVE_CIRCLE module returns a complete circle, FIND_CIRCLES saves the complete circle and removes those arcs from the input set of arcs. FIND_CIRCLES calls RETRIEVE_CIRCLE on the updated set of arcs repeatedly until RETRIEVE_CIRCLE returns an empty set φ. When the empty set is returned, no more circles can be found for the remaining arcs and the algorithm terminates.

An example of the pseudocode for this algorithm follows:

FIND_CIRCLES (A)

| | | |
|---|---|---|
| 1. | C := φ | // C is the set of |
| | | complete circles |
| 2. | X := RETRIEVE_CIRCLE(φ,A) | // If X is not φ, X is a |
| | | complete circle |

| | |
|---|---|
| 3. | while (X ≠ φ) { |

| | | |
|---|---|---|
| 4. | C :=CU ∪ {X} | // Save X in C |
| 5. | A := A\X | // Remove X from A |

| | |
|---|---|
| 6. | X := RETRIEVE_CIRCLE(φ,A) |
| 7. | } |

| | | |
|---|---|---|
| 8. | return (C, A) | // Return the complete |
| | | circles and the |
| | | // remaining set of arcs |

RETRIEVE_CIRCLE(X, A)

| | |
|---|---|
| 1. | If X is a complete circle |
| 2. | { |
| 3. | return X |
| 4. | } |
| 5. | For each arc y in A that extends X { |
| 6. | Y := RETRIEVE_CIRCLE(X ∪ {y}, A\{y }) |
| 7. | if (Y ≠ φ) { |
| 8. | return Y |
| 9. | } |
| 10. | } |
| 11. | return φ |

In another embodiment of the present invention for minimizing the required wavelengths and WICs in paired protections schemes for network configurations, a method of assigning the lightpath connections for connected components is provided. In this method, a set of lightpaths sharing end nodes are made into a path as a connected component and all of the lightpaths in the set are assigned to the same wavelength.

FIG. 6(b) is a flow chart illustrating an embodiment of this method. At step 700, a set of lightpath connections for the nodes in the ring is obtained. One of the lightpath connections from the set is selected at step 710. This selected lightpath connection is removed from the set at step 720 to define a linked component group of one or more lightpath connections bounded by its originating and terminating nodes. At step 725, a determination is made as to whether any lightpath connections remain in the set. If at least one lightpath connection remains, the remaining lightpath connection(s) in the set are examined at step 730 for determining whether any of these connections either terminates at the originating node of the linked component group or originates at the terminating node of the linked component group.

If it is determined at step 735 that one or more lightpath connection(s) exist, the candidate(s) of lightpath connection(s) are further analyzed at step 740 to determine whether they traverse any node(s) of already connected lightpath(s). At step 745, if it is determined that at least one of the candidate lightpath(s) does not traverse any already connected lightpath(s), one lightpath from the candidate lightpath(s) is selected at step 750 and the process proceeds to step 760 for examining any remaining lightpath connections. It is appreciated that various rules may be applied for selecting a lightpath when more than one lightpath candidate exists. For example, one rule is to select the longest linked component group that results in a minimum number of connected components after its removal. Other rules may be applied so that the lightpaths in the connected components of the linked component group are not fragmented after removing the set of selected lightpaths.

If it is determined at any of steps 725, 735 or 745 that no more lightpath connections or candidates remain, then the linked component group has been formed to its longest extent possible. Accordingly, the defined linked component group is assigned a unique wavelength at step 760. Similarly, if it is determined at step 765 that no more lightpaths remain, the linked component group is assigned a unique wavelength at step 770. Next, it is determined at step 770 whether any lightpath connections remain in the set. If at least one lightpath connection remains, the process proceeds to step 710 to select and examine the remaining lighpaths. Otherwise, the process ends at step 780 if no more lightpath connections remain in the set.

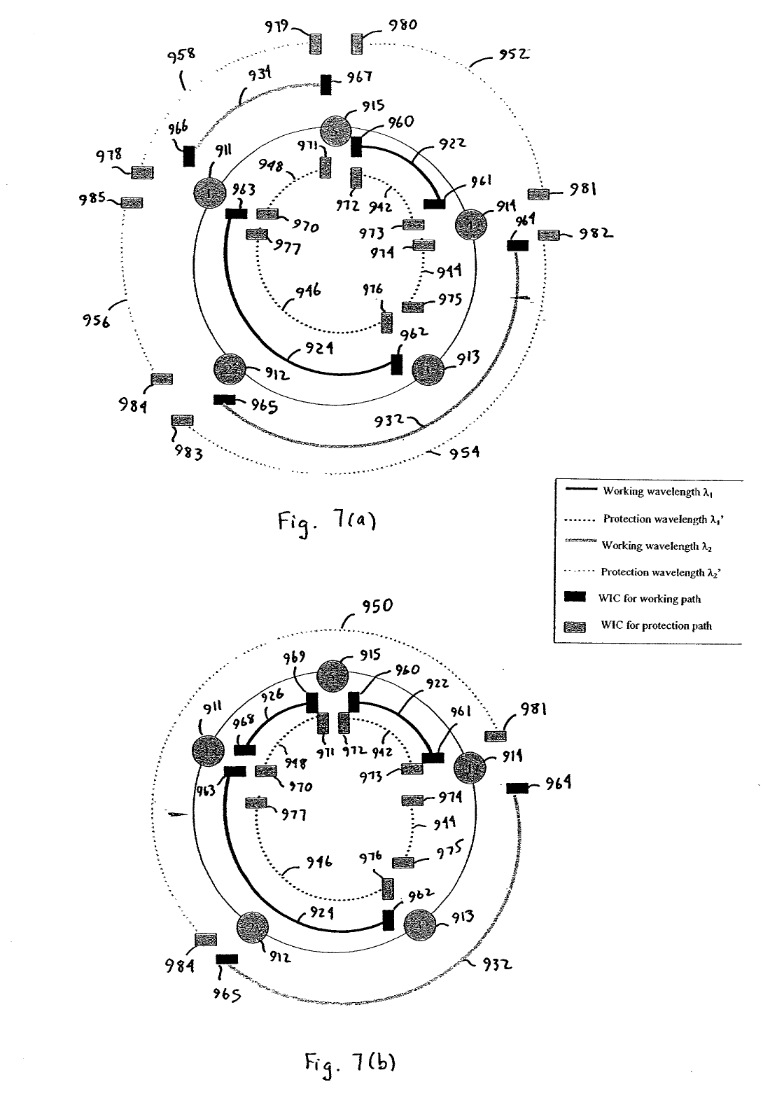

FIGS. 7(a) and 7(b) illustrate examples of how the reduction of fragmented segments by the present method reduces the amount of needed switching equipment. In FIG. 7 (a), two wavelengths λ₁ and λ₂ are provided for the four working path connections as shown in Table 4.

TABLE 4

| Reference | Connection | Nodes | Wavelength |
|---|---|---|---|
| 1 | 924 | (1, 3) | λ₁ |
| 2 | 922 | (4, 5) | λ₁ |
| 3 | 932 | (2, 4) | λ₂ |
| 4 | 934 | (5, 1) | λ₂ |

The protection path connections for FIG. 7(a) are shown in Table 5.

TABLE 5

| Reference | Connection | Nodes | Wavelength |
|---|---|---|---|
| 1′ | 948, 942, 944 | (1, 5) (5, 4) (4, 3) | λ₁′ |
| 2′ | 944, 946, 948 | (4, 3) (3, 1) (1, 5) | λ₁′ |
| 3′ | 956, 958, 952 | (2, 1) (1, 5) (5, 4) | λ₂′ |
| 4′ | 952, 954, 956 | (5, 4) (4, 2) (2, 1) | λ₂′ |

In this wavelength assignment example, 8 WICs (960-967) are needed for the working path connections and 16 WICS (970-985) are needed for the protection path connections for a total 16 WICs.

In the wavelength assignment of FIG. 7(b), connection 932 is shifted to the first wavelength λ₂ so that the working path connections are as shown in Table 6.

TABLE 6

| Reference | Connection | Nodes | Wavelength |
|---|---|---|---|
| 1 | 924 | (1, 3) | λ₁ |
| 2 | 922 | (4, 5) | λ₁ |
| 3 | 926 | (5, 1) | λ₁ |
| 4 | 932 | (2, 4) | λ₂ |

The corresponding protection path connections are as shown in Table 7.

TABLE 7

| Reference | Connection | Nodes | Wavelength |
|---|---|---|---|
| 1′ | 948, 942, 944 | (1, 5) (5, 4) (4, 3) | λ₁′ |
| 2′ | 944, 946, 948 | (4, 3) (3, 1) (1, 5) | λ₁′ |
| 3′ | 942, 944, 946 | (5, 4) (4, 3) (3, 1) | λ₁′ |
| 4′ | 950 | (2, 4) | λ₂′ |

In this wavelength assignment, 8 WICs (960-967) remain needed for the working path connections but only 10 WICS (970-977, 981, and 984) are needed for the protection paths. Therefore, the wavelength assignment of FIG. 7(b) reduces the total number of WICs to 18, as compared to the 24 WICs needed in the wavelength assignment of FIG. 7(a). By moving the working path connection 934 on wavelength λ₂ in FIG. 7(a) to the working path connection 926 on wavelength λ₁ in FIG. 7(b), fragmented lightpath connections are eliminated so a linked component group of lightpaths exists. As a result, the amount of necessary switching equipment is reduced.

Follow-up processing may be carried out to remove the number of unshared connection end nodes in shared wavelengths. This follow-up processing is applicable for use after completion of all of the above-described methods including the methods for completing a circle and for assigning the lightpath connections for connected components. In one example, some of the isolated lightpaths are moved to unused wavelengths so that each unused wavelength will be assigned exactly one lightpath.

FIGS. 7(c) and 7(d) illustrate how this follow-up processing can reduce the number of WICs in the network. In FIG. 7(c), all three lightpath connections 820, 822, and 824 for the working path connections are assigned to a first wavelength λ₁ while a second available wavelength λ₂ for the working path connections is not used. Segments of lightpath connections 830, 832, 834, 836 and 838 for the protection path connections on wavelength λ₁′ are also shown. In this example, 6 WICs (one WIC at each of nodes 811, 813, 814 and 815 and two WICs at node 812) are needed for the working path connections and 10 WICs (two WICs at each of nodes 811, 812, 813, 814 and 815) are needed for the protection path connections for a total of 16 WICs.

If the working path connection between nodes 814 and 815 is moved to the second wavelength λ₂ to form a working path connection 826, as illustrated in FIG. 7(d), the total number of WICs will be reduced by two. Segments of lightpath connections 840, 842, 844, and 850 for the corresponding protection path connections on wavelengths λ₁′ and λ₂′ are also shown in FIG. 7(d). By shifting the one connection to the unused working path wavelength, only 8 WICs (one WIC at each of nodes 814 and 815 and two WICs at each of nodes 811, 812 and 813) are needed for the protection path connections while 6 WICs remain necessary for the working path connections which leads to the reduction of two WICs.

In assigning filters for each wavelength assignment input, a hitting set formulation is utilized. For each node, a hitting set problem is formulated as a set of wavelengths that must be dropped (wavelengths assigned to circuits terminating at that node) and is defined as follows:

INPUT: A set of ground elements G={e₁, e₂ . . . eₙ}, each element eᵢ associated with weight wᵢ A family of sets F={S₁, S₂ . . . Sₘ}, where each set Sᵢ is a subset of G.

OUTPUT: A set A [symbol] G that shares at least one element with every Sᵢ in F, i.e., ∀ Sᵢ ε F, A∩Sᵢ≠Ø.

OBJECTIVE: Minimize the weight of A, i.e., weight sum of elements in A

In the hitting set formulation, weights are associated with the filters to reflect the impact when each filter is placed at a node. In one example of associating a weight with a filter for a lightpath assigned with a wavelength optically bypassing a node, the weight of a filter dropping the wavelength at that node is set to a large value. The weight is set to the large value because an optical patch-through is required for the wavelength at the node (and if an optical patch-through is not allowed, the weight would be set to infinity). The hitting set formulation provides an assignment of filters in which the sum of the weights of the filters is minimized. In general, a set of filters, F, with a minimum weight is sought so that the filter set will drop all of the necessary wavelengths at each node. The hitting-set formulation initializes a hitting-set problem instance for each node, finds the wavelength assigned, and updates the hitting-set instances for each node for each lightpath p.

More particularly, the weight of the filters is initialized and the set F is set to 0 before a lightpath is set up for any node. When a lightpath p is assigned a wavelength, λ₁ for example, the weight of each filter in the node is updated. For instance, if the lightpath p bypasses a node i, then the weights for the filters that drop λ₁ are increased in the hitting-set formulation for node i. Additionally, the filter set F for the nodes where the lightpath is added or dropped is updated. The end points of the lightpath and intermediate nodes where circuits in the lightpath terminate are also updated. The filter set F for each of these nodes will include a new element S, which contains the set of filters that drop λ₁.

Accordingly, the present methods for assigning working path connections in paired protection schemes minimizes the amount of switching equipment needed in network configurations. In particular, the wavelength connection assignment in the present invention reduces the combination of WICs and assigned wavelengths for the desired lightpath connections so that the advantages of the paired protection scheme may be realized while reducing the costs of the network.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A method for assigning a set of predetermined lightpath connections between nodes to wavelengths in a wavelength-division multiplexed optical ring communications network, comprising the steps of:
(a) determining whether a subset of the lightpath connections exists so that each of the nodes includes exactly one of an origination for one of the lightpath connections, a termination for one of the lightpath connections, and a traversal of one of the lightpath connections;
(b) assigning said subset determined at said step (a) to one of the wavelengths;
(c) removing said subset determined at said step (a) from said set of lightpath connections; and
(d) repeating said steps (a)-(c) until no more of said subsets are determined to exist.

2. The method according to claim 1, further comprising the steps of:
(e) determining whether any of the wavelengths do not have any of said lightpath connections assigned thereto;
(f) determining whether any of said lightpath connections remain in said set;
(g) selecting one of said lightpath connections determined to be remaining in said set at said step (f);
(h) moving said one lightpath connection selected at said step (g) to one of the wavelengths determined not to have any assigned lightpath connections at said step (e); and
(i) repeating said steps (e)-(h) until no more of the wavelengths are determined not to have any assigned lightpath connections at said step (e).

3. A method for assigning a set of predetermined lightpath connections to wavelengths in a wavelength-division multiplexed optical ring communications network, comprising the steps of:
(a) selecting one of the predetermined lightpath connections from the set to form a linked component group bounded by an originating node and a terminating node;
(b) removing said lightpath connection selected at said step (a) from the set;
(c) examining whether at least one of said lightpath connections remaining in said set either terminates at said originating node or originates at said terminating node;
(d) when at least one lightpath connection exists at said step (c), determining whether said at least one light path connection traverses any portion of said linked component group;
(e) when at least one lightpath connection is determined not to traverse any portion of said linked component group at said step (d), selecting one said lightpath connection to expand said linked component group to have either a different terminating node or a different originating node;
(f) removing said one lightpath connection selected from said set at said step (e);
(g) repeating said steps (c)-(f) until no more of said lightpath connections are selected at said step (e);
(h) assigning a wavelength to said linked component group when no more of said lightpath connections are selected at said step (e); and
(i) repeating said steps (a)-(h) until no more lightpath connections remain in the set.

4. The method according to claim 3, further comprising the steps of:
(j) determining whether any of the wavelengths do not have any lightpath connections assigned thereto;
(k) finding one of said lightpath connections isolated from said linked component group;
(l) moving said one lightpath connection found to be isolated at step (k) to one of the wavelengths determined not to have any assigned lightpath connections at said step (j); and
(m) repeating said steps (j)-(l) until no more lightpath connections are found to be isolated at said step (k).

5. The method according to claim 3, wherein said step (e) further comprises selecting the longest one of said lightpath connections which may be connected to said linked component group.

6. The method according to claim 3, wherein said step (e) further comprises selecting one of said lightpath connections which result in a minimum number of connected lightpath components after removal of said one lightpath connection.

7. The method according to claim 3, wherein step (e) further comprises selecting ones of said lightpath connections that minimize fragmented lightpaths from said linked component group.

8. A method for analyzing predetermined lightpath arcs in a wavelength-division multiplexed optical ring communications network to form complete lightpath circles around the ring, comprising the steps of:
(a) forming a partial circle from the predetermined lightpath arcs;
(b) iteratively identifying complete lightpath circle subsets of lightpath arcs which have been determined to form a complete lightpath circle from said partial circle;
(c) removing the lightpath arcs of each said complete lightpath circle subset from the remaining ones of the predetermined lightpath arcs; and
(d) repeating said steps (a)-(c) whenever one said complete circle subset is created until no more of said complete lightpath circle subsets are identified at said step (b).

9. The method according to claim 8, wherein said lightpath arcs comprise lightpath segments around the ring.

10. The method according to claim 8, wherein said partial circle comprises a set of said lightpath arcs which do not overlap any other segments of lightpaths in said set and form a continuous portion around the ring.

11. The method according to claim 8, wherein said complete lightpath circle comprises a set of said lightpath arcs which are joined together without overlapping to form one continuous lightpath around the ring.
